(19) United States
(12) Patent Application Publication
(10) Pub. No.: US 2024/0381875 A1
(43) Pub. Date: Nov. 21, 2024

(54) AGRICULTURAL SEED COATINGS WITH INCORPORATED ALUMINUM OXIDE AND METHODS FOR FORMING

(71) Applicant: PHOSPHOLUTIONS INC., State College, PA (US)

(72) Inventors: Aaron WALTZ, Rockford, IL (US); Kyle J. ISAACSON, Bradenton, FL (US); Pauline WELIKHE, Bellefonte, PA (US)

(21) Appl. No.: 18/692,207

(22) PCT Filed: Sep. 22, 2022
(86) PCT No.: PCT/US2022/044369

§ 371 Date: Mar. 14, 2024

Related U.S. Application Data
(60) Provisional application No. 63/247,574, filed on Sep. 23, 2021.

(51) Int. Cl. A01N 59/06; A01C 1/06; A01N 61/00; A01P 21/00

(52) U.S. Cl. CPC A01N 59/06; A01C 1/06; A01N 61/00; A01P 21/00

(57) ABSTRACT

An agricultural seed coating is disclosed herein including aluminum oxide particles disposed on a seed. A method for forming an agricultural seed coating is disclosed herein including introducing aluminum oxide powder and a seed into at least one of a dry coating apparatus, a rotary pan, or a pelletization pan.

### RELATED APPLICATIONS

This application claims the benefit of and priority to U.S. Provisional Patent Application No. 63/247,574, filed Sep. 23, 2021, entitled “Agricultural Seed Coatings with Incorporated Aluminum Oxide and Methods for Forming,” which is hereby incorporated by reference in its entirety.

### FIELD OF THE INVENTION

This application is directed to agricultural coatings with incorporated aluminum oxide. In particular, this application is directed to agricultural coatings with incorporated aluminum oxide on seeds.

### BACKGROUND OF THE INVENTION

Agricultural coatings are generally categorized as seed coatings, fertilizer coatings, and pesticide coatings, although all three coatings may be and are applied onto seeds, in which case they are collectively referred to as agricultural seed coatings. Indeed, while fertilizer and pesticide coatings can be applied elsewhere, they are most commonly applied to seeds. Therefore, seed coatings involve the placement of exogenous materials onto the surface of seeds. On the basis of formulation, seed coatings are designed to improve appearance and handling characteristics, such as size or seed weight. From an efficacy standpoint, seed coatings are most often engineered to deliver active compounds (such as growth regulators, nutrients, and/or microbial inoculants) to protect seeds from pathogens, increase germination, and augment long-term plant growth. Broadly, the components of seed coatings may be divided into three main categories: (1) active ingredients; (2) liquids; and (3) solid particulates. Active ingredients include biostimulants, plant nutrients, abiotic stress mitigators, plant protectants, and inoculants. Liquids include water, colorants, adjuvants, and binders. Solid particulates are most often binders or filler components.

Three major types of seed coating equipment which commonly employed are dry coating equipment, rotary pans, and pelletization pans. This equipment is used alone or in tandem to allow for five main coating methods: dry powder, seed dressing, film coating, encrusting, and pelleting (see FIG. 1). The choice of coating method alters the quantity of seed coating material that may be applied onto a single seed. For example, dry coatings generally only constitute 0.06-1% of the finished seed weight, seed dressings between 0.5-2%, film coats between 2-8%, encrustments between 8-500%, and pellets between 500-5,000%. Seed dressings are the most broadly used method for application of low dosages of active components, yet larger quantities require film coating, encrusting, or pelletization methods. While dry powder coatings do not utilize liquid components, seed dressings and film coatings do not generally allow use of solid particulates, though solid particulates are often employed post-coating as drying powders, finishing powders, or fluency agents to help absorb excess moisture.

It is well documented that fertilizer seed coatings and treatments may increase germination and improve overall yields in many crop varieties by improving the microenvironment around the seed. However, reports abound of fertilizer toxicity due to seed coatings, as excessive concentrations of plant nutrient ions in the immediate vicinity of seed and seedlings may detrimentally alter metabolic and growth pathways. As such, multiple seed coatings are engineered for controlled release of active ingredients to limit nutrient shock. In one strategy, this controlled release behavior in seed coatings is effected via creation of a dense polymer matrix that slows diffusion; however, controlled adsorption and desorption systems are occasionally utilized for specific active compounds. In many cases, active ingredients (in particular pesticides) incorporated into seed coatings have been found in unintended environmental locales (such as rivers, aquifers, soil, and others), indicating that a substantial portion of active ingredient does not interact with the seed or growing plant. Additionally, improperly formulated seed coatings may shield the seed from water, resulting in plant dehydration and delayed germination.

Aluminum oxide is well known to effectively adsorb multiple plant nutrients, most notably phosphorus and sulfur in a soil environment. These nutrients may selectively desorb in a pH-dependent and concentration-buffered manner, allowing for a controlled release system. Aluminum oxide has been applied to soils to regulate soil phosphorus buffering capacity and been shown to increase crop root growth while reducing the amount of phosphorus fertilization required. However, the distribution of aluminum oxide particles across soil may lead to sub-optimal plant fertilization and plant nutrient uptake. Random distribution of aluminum oxide particles across soil leads to certain aluminum oxide particles serving as effective plant nutrient release systems while others remain uninvolved in the soil dynamics and plant fertilization. Soil distribution of aluminum oxide and adsorbed nutrients is important in the pre-germination phase, as the growing crops are unable to seek out plant nutrients in the soil.

Agricultural seed coatings not suffering from the above-described limitations would be desirable.

### BRIEF DESCRIPTION OF THE INVENTION

In one exemplary embodiment, an agricultural seed coating includes aluminum oxide particles disposed on a seed.

In another exemplary embodiment, a method for forming an agricultural seed coating includes introducing aluminum oxide powder and a seed into at least one of a dry coating apparatus, a rotary pan, or a pelletization pan.

### BRIEF DESCRIPTION OF THE DRAWINGS

FIG. 1 illustrates three types of seed coating equipment: dry powder applicator, rotary coater, and drum coater used to produce five seed coatings: dry coating, seed dressing, film coat, encrustment, and see pellet (as further described in Afzal et al. Modern Seed Technology: Seed Coating Delivery Systems for Enhancing Seed and Crop Performance. Agriculture (2020) 10:526).

FIG. 2 is a bar graph detailing the number of seedlings emerging at Day 5 following planting of various inventive and comparative examples, according to embodiments of the present disclosure.

FIG. 3 is a bar graph detailing the number of seedlings emerging at Day 10 following planting of various inventive and comparative examples, according to embodiments of the present disclosure.

FIG. 4 is a bar graph detailing the shoot mass at Day 21 following planting of various inventive and comparative examples, according to embodiments of the present disclosure.

FIG. 5 is a bar graph detailing the root mass at Day 21 following planting of various inventive and comparative examples, according to embodiments of the present disclosure.

FIG. 6 is a bar graph detailing the total biomass mass at Day 21 following planting of various inventive and comparative examples, according to embodiments of the present disclosure.

FIG. 7 is a bar graph detailing the shoot phosphorus uptake at Day 21 following planting of various inventive and comparative examples, according to embodiments of the present disclosure.

FIG. 8 is a bar graph detailing the root phosphorous uptake at Day 21 following planting of various inventive and comparative examples, according to embodiments of the present disclosure.

FIG. 9 is a bar graph detailing the total phosphorous uptake at Day 21 following planting of various inventive and comparative examples, according to embodiments of the present disclosure.

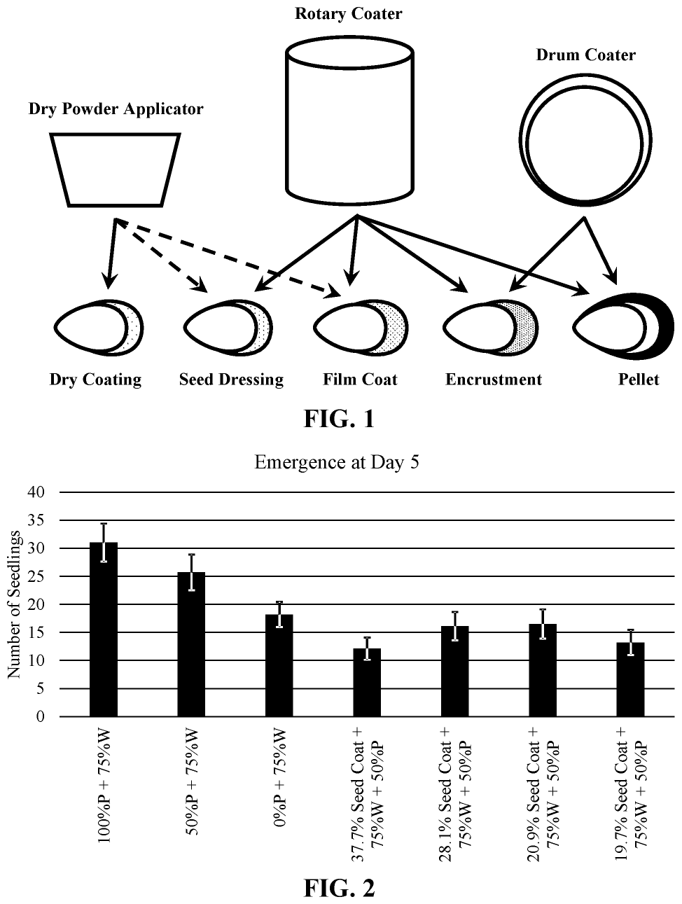

Wherever possible, the same reference numbers will be used throughout the drawings to represent the same parts.

### DETAILED DESCRIPTION OF THE INVENTION

Disclosed herein are agricultural seed coatings incorporating aluminum oxide. The aluminum oxide may be powdered aluminum oxide milled to appropriate size (including, but not limited to, −200 mesh) and may be incorporated into any of the five principal seed coating methods (dry powder, seed dressing, film coating, encrusting, and pelleting). Powdered aluminum oxide may be incorporated as a finishing powder, drying powder, fluency agent, or combinations thereof in seed dressings and film coatings, or any other seed coating structures or methods. The aluminum oxide may regulate the utilization of active ingredients by the seed via selective adsorption and desorption throughout the germination process, buffer phosphorus use, aid in improving seed storage stability and material handling, act as a hygroscopic agent, or combinations thereof. In one embodiment, localizing aluminum oxide with adjuvants and plant nutrients adjacent to the seed promotes the adjuvant to remain adequately close to the plant to control nutrient release and plant uptake in the early stages of plant growth.

The aluminum oxide may be any suitable material, including, but not limited to, alumina (also referred to as α-alumina, Al₂O₃, and aluminum (III) oxide), artificial corundum, natural corundum, β-alumina (NaAl₁O₁₇), cubic γ-Al₂O₃, cubic η-Al₂O₃, monoclinic θ-Al₂O₃, hexagonal x-Al₂O₃, orthorhombic K—Al₂O₃ and tetragonal or orthorhombic δ-Al₂O₃, bauxite, alumina trihydrate, alumina monohydrate, boehmite, pseudobochmite, gibbsite, bayerite, or combinations thereof. As used herein, “aluminum oxide” is understood to include aluminum oxide hydrates and aluminum oxide hydroxides.

In one embodiment, the agricultural seed coating includes an aluminum oxide layer directly contacting a seed. In another embodiment, the aluminum oxide layer is separated from direct contact with the seed by an intermediate layer. The aluminum oxide layer may consist of aluminum oxide, consist essentially of aluminum oxide (optionally in addition to fillers, colorants, binder, other inactive ingredients, or combinations thereof), or may further include additional active ingredients, such as, but not limited to, nutrients, fertilizers, biostimulants, pesticides, abiotic stress mitigators, plant protectants, inoculants, water, adjuvants, or combinations thereof.

The nutrients may include, but are not limited to, bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, or combinations thereof.

The biostimulants include, but are not limited to, humics, fulvics, living microbes, microbial metabolites, plant extracts, exogenous plant hormones, or combinations thereof.

In one embodiment, the agricultural seed coating is formed on a seed by introducing aluminum oxide powder and the seed into a dry coating apparatus, a rotary pan, a pelletization pan, or combinations thereof. The agricultural seed coating may be formed on the seed as a dry powder, a seed dressing, a film coating, an encrusting, a pelleting, or combinations thereof.

In one embodiment, the agricultural seed coating is formed on seeds prior to transportation of the seeds with the agricultural seed coating to a farm. In another embodiment, an agricultural seed coating powder, having all of the constituents of the agricultural seed coating, is transported to a farm prior to being formed into the agricultural seed coating on the seeds at the farm.

### EXAMPLES

Seed coating for plant grow room studies were prepared by mixing aluminum oxide with water at varying concentrations and soaking seeds in the resulting thixotropic mixtures. Seeds were weighed before and after coating to estimate seed coating weight. Four different seed coating formulations were obtained (37.7 wt %, 28.1 wt %, 20.9 wt %, 19.7 wt % based on the seed coating as a percent of total coated seed weight).

Inventive and comparative compositions were tested to study the effects of seed coating on plant growth (perennial ryegrass). All percentages and ratios herein are given by weight. Plant growth testing conditions included a mixture of graded fine 100% sand and peat moss at a 13.33:1 sand: peat ratio as the soil (with both 100 wt % and 75 wt % water; low nitrogen (10 kg N/ha); 0%, 50%, and 100% phosphorus (100% P being defined as 45.4 kg P₂Os/ha); and low potassium (10 kg K₂O/ha)) disposed in six-inch square pots having 900 g medium per pot with 127.69 cm² surface area. Ten replications per treatment were performed with 0.5 g seeds per pot. The light source was 300-350 μmol/m²/s with a 16-hour light and 8-hour dark cycle at 28° C. under light and 22° C. under dark. Fertilizer was applied (10-0-32 (N—P₂O₅—K₂O) at a concentration of 0.1 g per pot one time upon planting; monoammonium phosphate 11-52-0 (N—P₂O₅—K₂O) at varying concentrations of P₂Os per pot one time upon planting, urea 46-0-0 (N—P₂O₅—K₂O) was supplemented as needed one time upon planting to ensure a total of 0.032 g N per pot). On Day 10, the growth was thinned to 30 seedlings per pot to standardize subsequent biomass increase for comparison. Growth was monitored for 21 days total, and both root and shoot biomass were analyzed.

Referring to FIGS. 2-6, “75% W” indicates 75 wt % water, and “50% P” indicates 50 wt % phosphorus.

Referring to FIG. 2, at Day 5 following planting for the various uncoated and coated seed treatments, the phosphorus controls clearly show that the plants and soil were phosphorous-responsive and that seed coating with aluminum oxide delayed emergence.

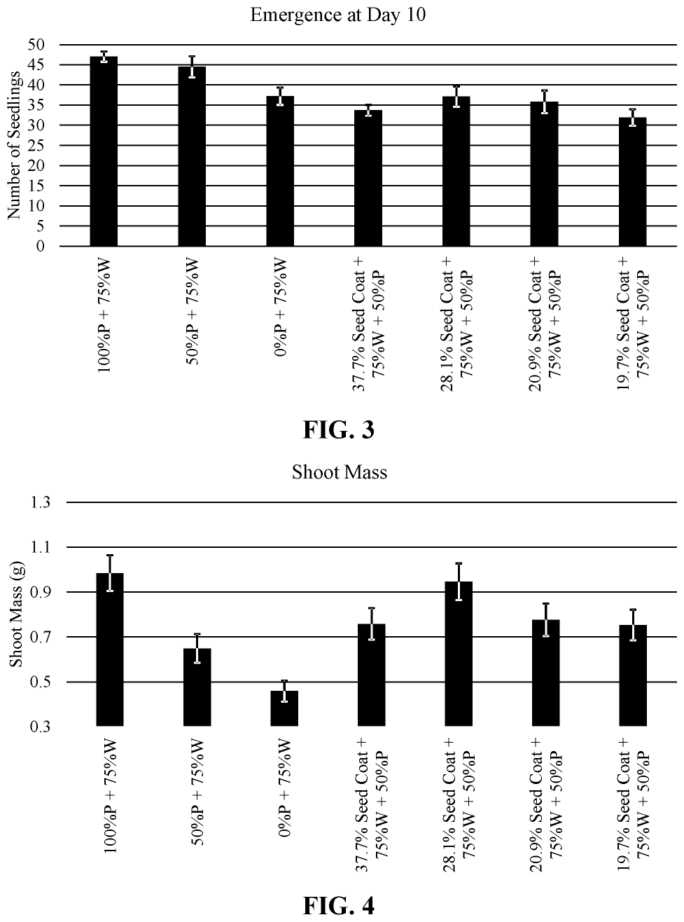

Referring to FIG. 3, at Day 10 following planting for the various uncoated and coated seed treatments, the phosphorus controls clearly show that the plants and soil were phosphorous-responsive and that seed coating with aluminum oxide delayed emergence.

Referring to FIG. 4, at Day 21 following planting for the various uncoated and coated seed treatments, the phosphorus controls clearly show that the plants and soil were phosphorous-responsive and that despite the observed delay in emergence, shoot mass of the coated seed treatments exceeded that of the 50 wt % phosphorous control, indicating improved above-ground growth compared to uncoated seeds.

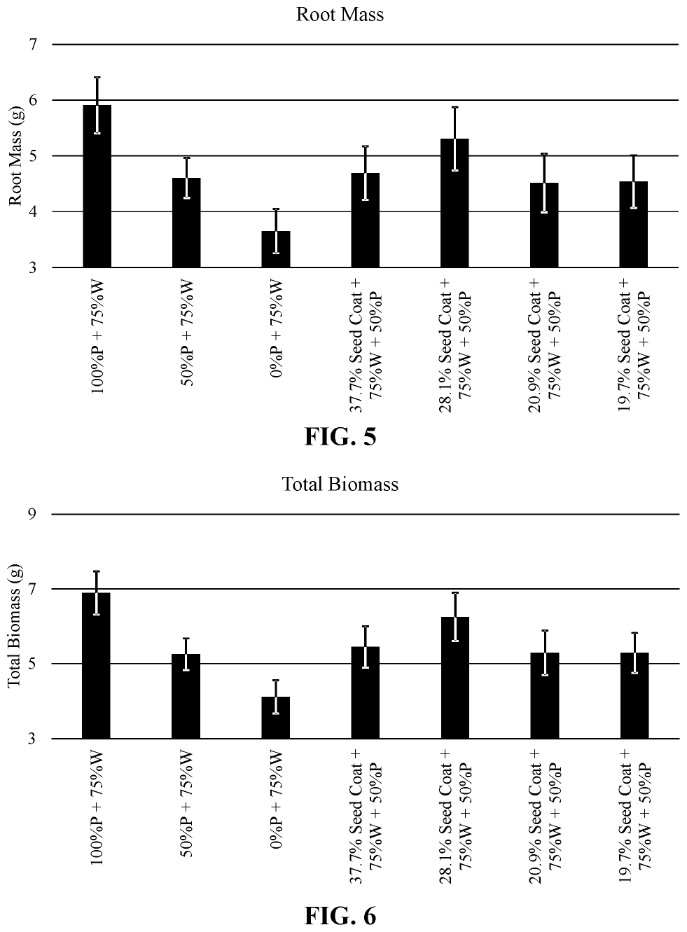

Referring to FIG. 5, at Day 21 following planting for the various uncoated and coated seed treatments, the phosphorus controls clearly show that the plants and soil were phosphorous-responsive and that despite the observed delay in emergence, root mass of the coated seed treatments exceeded that of the 50 wt % phosphorous control, indicating improved below-ground growth compared to uncoated seeds.

Referring to FIG. 6, at Day 21 following planting for the various uncoated and coated seed treatments, the phosphorus controls clearly show that the plants and soil were phosphorous-responsive and that despite the observed delay in emergence, total biomass of the coated seed treatments exceeded that of the 50 wt % phosphorous control, indicating improved growth compared to uncoated seeds.

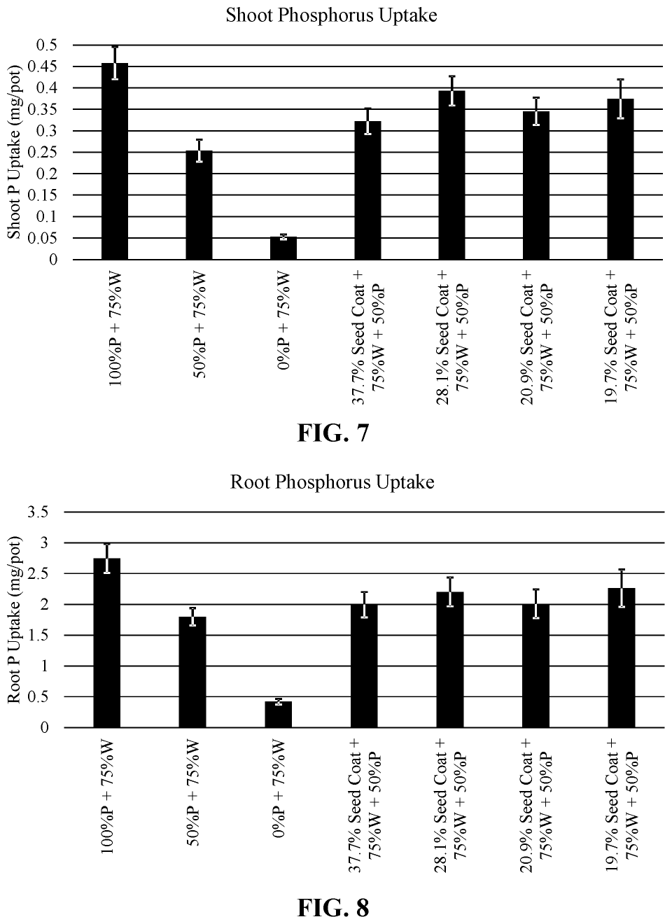

Referring to FIG. 7, at Day 21 following planting for the various uncoated and coated seed treatments, all coated seed treatments showed increased phosphorous uptake compared to the 50 wt % phosphorous control despite delayed emergence.

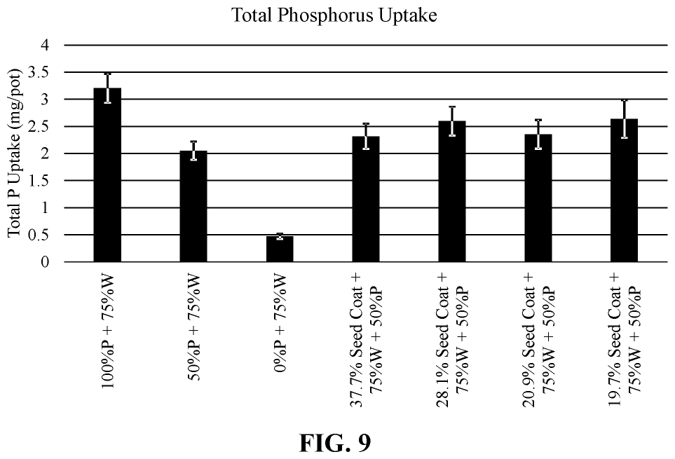

Referring to FIG. 8, at Day 21 following planting for the various uncoated and coated seed treatments, all coated seed treatments showed increased phosphorous uptake compared to the 50 wt % phosphorous control despite delayed emergence.

Referring to FIG. 9, at Day 21 following planting for the various uncoated and coated seed treatments, the coated seed treatments showed increased total phosphorous uptake (combined root and shoot) compared to the 50 wt % phosphorous control despite delayed emergence.

As used herein, “about” indicates a variance of up to 10% from the value being so modified. All values modified with “about” are also intended to convey the unmodified value as an alternative, so that “about 10 μm,” by way of examples, discloses both a range of 9-11 μm as well as specifically 10 μm.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims, including combinations of the embodiments disclosed herein.

1. An agricultural seed coating, comprising aluminum oxide particles disposed on a seed, wherein the aluminum oxide particles constitute an aluminum oxide seed dressing, an aluminum oxide film coating, an aluminum oxide encrusting, or an aluminum oxide pelleting constituting 2% to 98% of total coated seed weight.

2. The agricultural seed coating of claim 1, wherein the aluminum oxide particles are selected from the group consisting of α-alumina, artificial corundum, natural corundum, β-alumina γ-Al₂O₃, η-Al₂O₃, θ-Al₂O₃, x-Al₂O₃, K—Al₂O₃, δ-Al₂O₃, bauxite, alumina trihydrate, alumina monohydrate, boehmite, pseudoboehmite, gibbsite, bayerite, and combinations thereof.

3. (canceled)

4. The agricultural seed coating of claim 1, wherein the aluminum oxide particles form an aluminum oxide layer directly contacting the seed.

5. The agricultural seed coating of claim 1, wherein the aluminum oxide particles form an aluminum oxide layer separated from direct contact with the seed by an intermediate layer.

6. The agricultural seed coating of claim 1, wherein the aluminum oxide particles form an aluminum oxide layer consisting of the aluminum oxide particles.

7. The agricultural seed coating of claim 1, wherein the aluminum oxide particles form an aluminum oxide layer consisting essentially of the aluminum oxide particles, further including at least one of a filler, a colorant, or a binder.

8. (canceled)

9. The agricultural seed coating of claim 1, wherein the aluminum oxide particles form an aluminum oxide layer including the aluminum oxide particles and at least one additional active ingredient.

10. The agricultural seed coating of claim 9, wherein the at least one additional active ingredient includes at least one of a nutrient, a fertilizer, a biostimulant, a pesticide, an abiotic stress mitigator, a plant protectants, an inoculants, water, or an adjuvant.

11. The agricultural seed coating of claim 10, wherein the at least one additional active ingredient includes at least one bioavailable species of phosphorus, molybdenum, selenium, zinc, copper, cobalt, iron, nickel, manganese, vanadium, calcium, potassium, sulfur, chlorine, silicon, magnesium, sodium, nitrogen, or boron.

12. The agricultural seed coating of claim 10, wherein the at least one additional active ingredient includes at least one of a humic, a fulvic, a living microbe, a microbial metabolite, a plant extract, or an exogenous plant hormone.

13. The agricultural seed coating of claim 1, wherein the aluminum oxide particles have size of about-200 mesh.

14. The agricultural seed coating of claim 1, further including at least one additional domain present as a distinct domain, wherein the at least one additional domain is selected from the group consisting of at least one nutrient domain, at least one pesticide domain, at least one biological additive domain, and combinations thereof.

15. (canceled)

16. The agricultural seed coating of claim 1, wherein the agricultural seed coating is disposed on the seed in the form of a seed dressing.

17. The agricultural seed coating of claim 1, wherein the agricultural seed coating is disposed on the seed in the form of a film coating.

18. The agricultural seed coating of claim 1, wherein the agricultural seed coating is disposed on the seed in the form of an encrusting.

19. The agricultural seed coating of claim 1, wherein the agricultural seed coating is disposed on the seed in the form of a pelleting.

20. A method for forming an agricultural seed coating, comprising introducing aluminum oxide powder and a seed into at least one of a dry coating apparatus, a rotary pan, or a pelletization pan.

21. The method of claim 20, wherein the agricultural seed coating is formed on the seed prior to transportation of the seed with the agricultural seed coating to a farm.

22. The method of claim 20, wherein an agricultural seed coating powder, having all of the constituents of the agricultural seed coating, is transported to a farm prior to being formed into the agricultural seed coating on the seed at the farm.

23. An agricultural seed coating, comprising aluminum oxide particles disposed on a seed, wherein the aluminum oxide particles are selected from the group consisting of bauxite, boehmite, pseudoboehmite, and combinations thereof.
